(19) United States
(12) Patent Application Publication
(10) Pub. No.: US 2017/0121090 A1
(43) Pub. Date: May 4, 2017

(54) FOOD TRAY AND METHOD FOR PRODUCING SUCH A FOOD TRAY

(71) Applicant: TORUS PAK RESEARCH AND DEVELOPMENT S.A.R.L, Luxemboung (LU)

(72) Inventor: Rickard Gillblad, Onsala (SE)

(21) Appl. No.: 15/319,672

(22) PCT Filed: Jun. 17, 2015
(86) PCT No.: PCT/EP2015/063652

§ 371 Date: Dec. 19, 2016

(30) Foreign Application Priority Data
Jun. 17, 2014 (EP) PCT/EP2014/062753

(51) Int. Cl. B65D 77/30; B65D 77/20; B65B 7/28; B23K 26/38; B65D 81/34; B29C 45/00; B29D 22/00; B23K 26/00; B65D 1/34; A47G 23/06

(52) U.S. Cl. CPC B65D 77/30; B65D 1/34; B65D 77/2024; B65B 7/2878; A47G 23/06; B65D 81/3453; B29C 45/0001; B29D 22/003; B29C 45/0053; B23K 26/0087; B23K 26/38; B29L 2031/712

(57) ABSTRACT

A food tray comprising a side wall module and a removable bottom, where the removable bottom comprises a rim section which is attached to a lower rim of the side wall module, where the rim section is fixedly attached to the lower rim of the side wall module and that the removable bottom is provided with a perforation adjacent the rim section, such that the removable bottom can be removed from the rim section by the use of a removal means attached to the removable bottom. One advantage of the method is that a food tray having a removable bottom is provided for in an easy and cost-effective way. In this way, a food tray that allows food to be transferred from the bottom of the food tray to a serving surface by removing the bottom is obtained.

### TECHNICAL FIELD

The present invention relates to a food tray adapted for ready meals and the like comprising a removable bottom and a method for producing such a food tray.

### BACKGROUND ART

There is an increasingly large demand for meals that are simple to prepare and for which the preparation time is short. Sales of convenience foods or ready meals are increasing. These are sold in disposable packages and are adapted either to be eaten directly without heating, such as sushi, or to be heated before eaten.

Most ready meals are contained in a disposable package usually consisting of a tray manufactured from cardboard, metal or a plastic material with a thin, transparent plastic film serving as a lid. A plurality of different heating methods is available, depending on the packaging material. The most common tray material for single portion ready meals is plastic or paper, which allows the meal to be heated in a microwave oven. It is also possible to use a conventional oven or to place the package in hot water. The lid of the package is removed either before or after heating.

The meal can be eaten directly from the package when heated or it is possible to transfer the food from the package to a plate. During a transfer of the food, the presentation of the meal is destroyed and the food content will inevitable mix. If the food is frozen, it may be possible to transfer the food to a plate prior to heating without too much problems, but for a non-frozen meal, the transfer of food is not practical. It is further an advantage to heat the meal in the package before moving it to a plate.

One way of solving the problem with the food mixing is to use a food package having a removable bottom, which is removed by the use of a pulling tab. The food package is placed on a plate before or after it is heated, and the bottom is removed by the use of the pulling tab. In this way, the food will be placed on the plate with the same presentation as in the food package, which will enhance the eating experience. Such a food package is disclosed in WO 2006/115457.

Such a food package is produced by injection moulding a container part without a bottom, i.e. a container part substantially only comprising side walls with upper and lower rims is produced. A removable bottom consisting of a relatively thin foil is then attached to the bottom rim of the container part in a detachable manner. The removable bottom comprises a removal tab to be used to remove the bottom.

Since food packages are disposable, production cost is an important parameter. There are several different plastic materials that can be used to form a container part without a bottom by injection moulding, in order to be able to provide a food tray with a removable bottom. However, most plastic materials that can be used for injection moulding are relatively expensive. One material that is suitable for disposable food trays is polypropylene (PP), also known as polypropene. Polypropylene has good injection moulding properties and is relatively cheap and is further recyclable which is of advantage for disposable packages.

One drawback of polypropylene is the relatively low melting temperature. A food tray made from polypropylene that is adapted to comprise the food when heating is well suited for the use of a microwave oven for the heating of the food. The microwave oven does not heat the package and the food is not heated to very high temperatures. A maximal usable temperature for a polypropylene package is 121° C. When using a regeneration oven to heat frozen food in a polypropylene food tray, the temperature is set to a relatively low temperature, typically to a temperature between 80° C. up to 115° C., which gives a relatively long heating time, in the order of 45 minutes to 60 minutes, depending on the type of food.

For some use, such as catering ovens used e.g. in airplanes or trains, a more rapid heating is of advantage. This is due both to limited space and limited time. The regeneration oven is thus set to a higher temperature, typically in the range between 150° C. to 220° C. Especially for airplanes, only the two oven temperatures of 180° C. and 210° C. are approved for heating food. In this case, polypropylene food trays cannot be used.

There is thus room for an improved food tray having a removable bottom.

### DISCLOSURE OF INVENTION

An object of the invention is therefore to provide an improved food tray comprising a removable bottom. A further object of the invention is to provide a method for producing an improved food tray comprising a removable bottom.

The solution to the problem according to the invention is described in the characterizing part of claim 1 for the food tray and in claim 8 for the method. The other claims contain advantageous embodiments and further developments of the food tray and of the method.

In a food tray comprising a side wall module and a removable bottom, where the removable bottom comprises a rim section which is attached to a lower rim of the side wall module, the object of the invention is solved in that the rim section is fixedly attached to the lower rim of the side wall module and that the removable bottom is provided with a perforation adjacent the rim section, such that the removable bottom can be removed from the rim section by the use of a removal means attached to the removable bottom.

By this first embodiment of the food tray according to the invention, a food tray having a removable bottom is provided for. The rim section of the removable bottom is fixedly attached to the lower rim of the side wall module, which simplifies the attachment of the removable bottom to the lower rim considerably. In prior art food trays having a removable bottom, the removable bottom is attached to the lower rim of the side wall module in a detachable way, which is a relatively expensive and difficult method. Since the attachment of the removable bottom is made by a heat sealing process, it is important that the heating sealing properties are absolutely right. If the attachment seal is not heated enough, the removable bottom will not adhere to the lower rim and the bottom may leak, and if the attachment seal is heated too much, the removable bottom will be difficult to remove.

With the inventive food tray, a food tray having a removable bottom, where the removable bottom is attached to the lower rim of the side wall module in a fixed way is provided. By attaching the removable bottom in a fixed way, the heat sealing process is simplified and a more consistent result is obtained. The removable bottom is thus provided with rim section which is attached to the lower rim and is further provided with a perforation adjacent the rim section, such that the removable bottom can be removed from the side wall module by breaking the perforation. The removable bottom is further provided with a removal means in the form of a tab which is fixedly attached to the removable bottom, close to the perforation. The tab is used to remove the removable bottom by pulling. The tab is attached at an opposite end of the removable bottom and is double folded, such that the tab opens the removable bottom at a side opposite the handle of the pulling tab.

When the tab is pulled, the perforation will break and the removable bottom will be pulled towards the handle side of the side wall module, starting with the short side opposite the handle side. The rim section will remain fixedly attached to the lower rim of the side wall module. The removable bottom is preferably perforated at the short side opposite the handle side and at the two long sides of the side wall module. The removable bottom may also be perforated at the handle side, but this is not necessary. Normally when a food tray having a removable bottom is opened, the removable bottom is not removed completely. The removable bottom is opened and the side wall module is removed from the plate together with the removable bottom, which is still attached to the side wall module at a short side.

In one example of the food tray, the removable bottom is attached to the inner side of the lower rim. This is of advantage if the side wall module is produced in a thermoforming method where the bottom part of the side wall module is removed in order to provide a lower opening of the side wall module. In such a production, the food tray is produced with the upper rim pointing upwards, i.e. with the same orientation as the food tray is to be used in. By applying the removable bottom on the inner side of the lower rim from above, the orientation of the side wall module must not be altered during production.

The removable bottom is preferably cut in a separate process. The removable bottom is made from a roll of foil and may be cut by a laser, which at the same time cuts the perforation of the removable bottom. The perforation is a weakening of the removable bottom and may be a continuous semi-cut line, e.g. cut half way through the foil of the removable bottom. It is important that the perforation does not extend through the bottom foil.

After the removable bottom has been attached to the lower rim of the side wall module, the removal tab is attached to the removable bottom in a fixed manner. The tab is attached to the removable bottom close to the perforation, at the central part of the removable bottom. The tab preferably extends over the complete short side of the removable bottom, but may also be attached at a corner of the removable bottom.

In a method for producing a food tray, where the food tray comprises a side wall module and a removable bottom, where the bottom comprises a rim section, where the rim section of the removable bottom is attached to the side wall module in a fixed manner, and where the removable bottom can be removed from the side wall module by the use of a removal means attached to the removable bottom, the method comprises the steps of producing a side wall module having side walls and a lower opening, producing a bottom foil, where the bottom foil comprises a perforation along the rim section, attaching the rim section of the bottom foil to a lower rim of the side wall module in a fixed manner, and attaching the removal means to the removable bottom in a fixed manner.

By this first embodiment of the method for producing a food tray according to the invention, the method comprises the step of producing a bottom foil comprising a perforation along a rim section. The bottom foil is thereafter attached to the lower rim of the side wall module in a fixed way, and a removal means is attached to the bottom foil in a fixed way. In this way, a food tray having a removable bottom can be produced in a cost-effective and efficient way.

The side wall module is preferably produced in a thermoforming process. One advantage of this method is that food trays having a removable bottom adapted for higher heating temperatures, e.g. temperatures exceeding 115° C. and e.g. ranging between 150° C. up to 210° C. can be produced. A further advantage is that the production of food trays can be distributed to production facilities producing smaller quantities of food trays, since there is no need to use injection moulding for the production. The bottom part of such a side wall module must be removed, e.g. by cutting or stamping, before a removable bottom can be attached.

### BRIEF DESCRIPTION OF DRAWINGS

The invention will be described in greater detail in the following, with reference to the embodiments that are shown in the attached drawings, in which

FIG. 1 shows a side view of a food tray comprising a removable bottom according to the invention,

FIG. 2 shows a cross section of a food tray according to FIG. 1,

FIG. 3 shows a bottom view of a food tray according to the invention, and

FIG. 4 shows a schematic flow chart of the method according to the invention.

### MODES FOR CARRYING OUT THE INVENTION

The embodiments of the invention with further developments described in the following are to be regarded only as examples and are in no way to limit the scope of the protection provided by the patent claims.

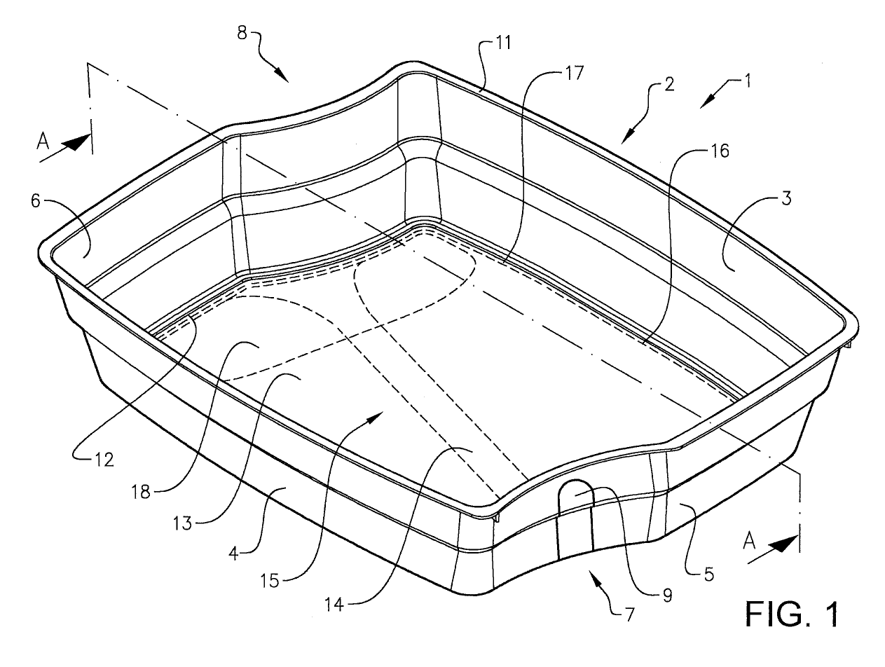

FIG. 1 shows an embodiment of a food package in the form of a food tray 1. The food tray 1 comprises in the shown example a side wall module 2 having two longitudinal side walls 3, 4 and two transverse side walls 5, 6 interconnected to each other, thereby forming the side wall module 2 made in one piece. The food tray further comprises a removable bottom 13 attached to the lower rim 12 of the side wall module. The removable bottom 13 closes off a lower opening 15 of the side wall module 2. The side walls 3, 4 and 5, 6 are substantially perpendicular to each other, but the side wall module may also have other shapes, such as a round, an oval or an asymmetric shape. A rectangular outer shape is however cost-efficient both to handle and to pack in larger quantities. The shown transverse side walls each comprise a concave section 7, 8. The concave section 7 is intended to hold the handle 9 of the removal tab 14 of the removable bottom and to provide a grip for holding the food tray when the removable bottom is removed. The removal tab 14 is attached to the removable bottom at the opposite end, at the concave section 8, which means that the removable bottom will start to peel off from this end when the removal tab is pulled. The transverse side wall 5 together with the concave section 7 is also referred to as the handle side of the food tray.

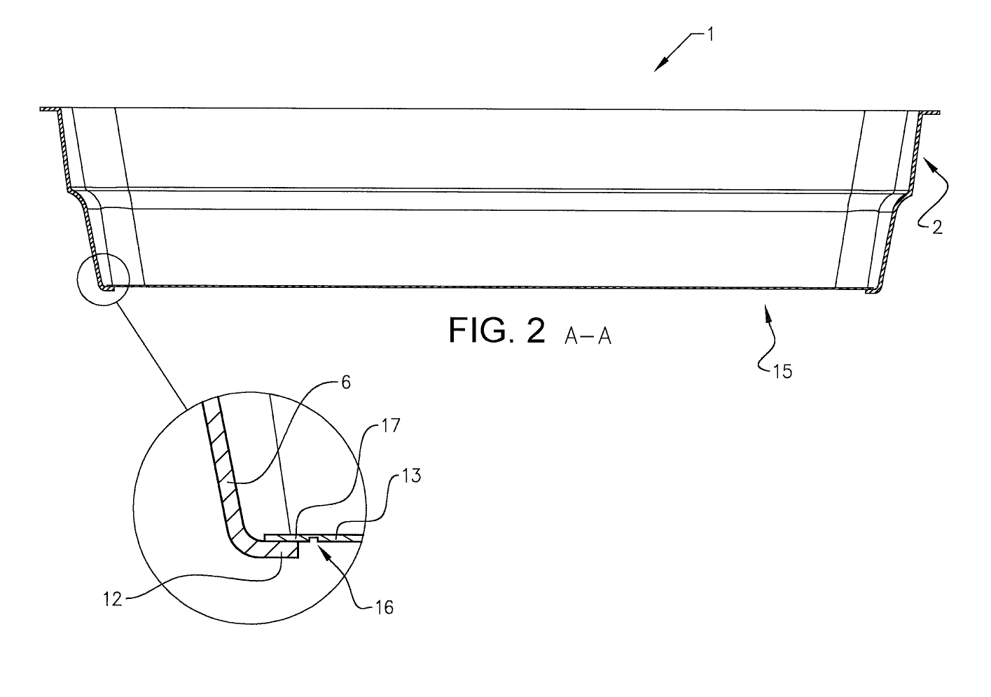

The side walls slope somewhat such that the food trays can be stacked in each other. This allows for an efficient transportation of empty food trays. The lower periphery of the side wall module is provided with a lower rim 12 that is adapted to receive a bottom foil that will constitute the removable bottom 13 of the food tray. The bottom foil may be attached either to the upper side of the rim 12, i.e. the inner side of the rim 12, as shown in FIG. 2, or to the underside of the lower rim 12, i.e. the outer side of the rim, as shown in FIG. 1.

In one example of the food tray, the removable bottom is attached to the inner side of the lower rim. This is of advantage if the side wall module is produced in a thermoforming method where the bottom part of the side wall module is removed in order to provide a lower opening of the side wall module. In such production, the food tray is produced with the upper rim pointing upwards, i.e. with the same orientation as the food tray is intended to be used. By applying the removable bottom on the inner side of the lower rim from above, the orientation of the side wall module must not be altered during production. The pre-cut bottom foil is held by a vacuum head and is pressed down on the rim 12, where the foil is heated in order to attach to the rim in a fixed manner.

In another example of the food tray, the removable bottom is attached to the outer side of the lower rim. This is of advantage when the side wall module is produced by injection moulding. Here, the side wall module is produced with the lower rim 12 pointing upwards and with the side wall module “upside down”, i.e. in the opposite orientation as the food tray is to be used. A foil is then applied to the lower rim from a roll of foil and the foil is heated at the rim such that the bottom foil attaches to the rim in a fixed manner. It is also in this method possible to attach the bottom foil to the side wall module without having to turn the side wall module over. By applying the removable bottom on the outer side of the lower rim from above, the orientation of the side wall module must not be altered during production. When the bottom foil has been attached to the rim, it is cut out from the roll of foil.

The removable bottom is attached in a fixed manner to the lower rim 12. The removable bottom is further provided with a perforation or weakening 16 running along the outer side of the removable bottom 13. The perforation 16 delimits the central part of the removable bottom from a rim section 17 running along the outer periphery of the removable bottom. The rim section 17 runs along the complete outer periphery of the removable bottom. The removable bottom is fixedly attached to the lower rim 12 of the side wall module by the rim section 17 in a heat transfer process.

The perforation 16 runs along at least three sides of the removable bottom, adjacent the longitudinal side walls 3 and 4 of the side wall module and along the transverse side wall 6. Since the removable bottom is pulled towards the side wall 5, i.e. the handle side of the side wall module, the lower opening 15 will be completely opened when the removable bottom is pulled away from these three sides. The food in the food tray has been transferred to the serving surface and the food tray together with the removable bottom can be lifted away from the plate without having to remove the removable bottom completely from the side wall module, i.e. from the side wall 5. It is of course also possible to provide a perforation also along this side if required.

The removable bottom can be removed from the side wall module by pulling the handle 9 of the removal tab 14. When the removal tab is pulled, the perforation of the removable bottom will break and the removable bottom will be peeled off, starting from the side wall 8 where the removal tab is attached to the removable bottom. The removal tab 14 is attached to the removable bottom 13 with an attachment section 18. The attachment section 18 preferably extends over the complete width of the removable cover, i.e. along transverse side wall 6. The removal tab is further attached to the removable bottom such that the removal tab can be double folded. This ensures that the pulling force will be applied as close to the perforation as possible, and that the removal tab can be peeled off in a reliable way. The attachment section 18 is attached close to the perforation in order to be able to apply a pulling force that will break the perforation when removing the removable bottom. The attachment of the removal tab is made after the removable bottom is attached to the side wall module, and is e.g. made by using heat or ultrasonic waves.

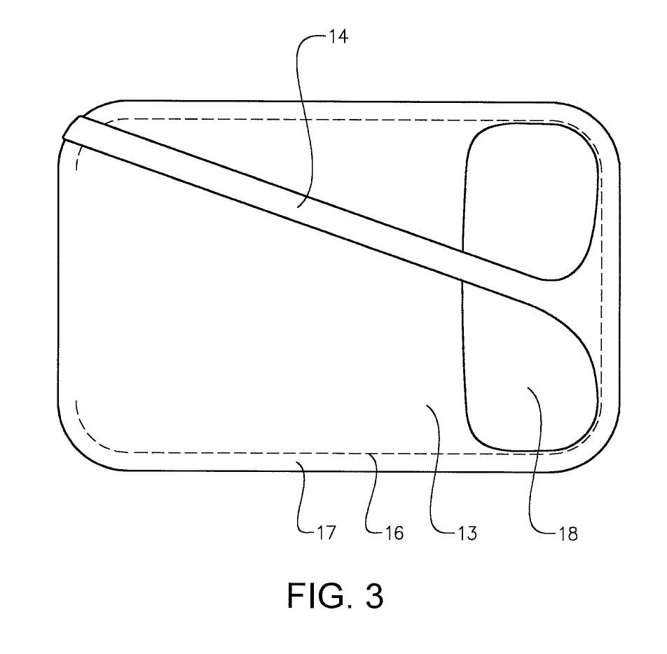

FIG. 3 shows a bottom view of a food tray according to the invention. Here it is shown an example where the perforation extends along three sides of the removable bottom. It is further seen that the attachment section of the removal tab is attached close to the perforation and that the removal tab is double folded and angled slightly, extending from the middle of the removable bottom to a corner of the food tray. This simplifies the removal of the removable bottom since the pulling forces will act with an angle, starting to remove the removable bottom at a corner.

The upper periphery of the food package comprises an upper rim 11 that is adapted to receive a lid of some kind. The lid may be made from different materials but is preferably a transparent film that is attached to the upper rim after food has been placed in the tray. The lid does not have to be removed from the tray when the food in the tray is to be served. The lid may thus be attached to the upper rim in a fixed manner. This allows for an easier attachment of the lid, which is of great importance especially when the food tray is used by smaller establishments having simpler sealing machines. A removable lid requires higher tolerances when the lid is attached to the tray, but with the inventive tray, a tight and secure attachment of the lid may be obtained also with lower tolerances.

The side wall module 2 is provided with a lower opening 15 delimited by the lower rim 12 of the side wall module. The lower opening covers substantially the complete bottom plane of the side wall module. In this way, everything that is placed on the removable bottom 13 in the food tray will arrive at the plate on which the food tray is placed, when the removable bottom is removed. FIG. 2 shows a cross section of the food tray 1.

Food trays of this type may be produced using an injection moulding process or a thermoforming process. Injection moulding is a cost-effective process that is used when large quantities of food trays are produced. The material used for injection moulding is polypropylene, which is a relatively cheap material. One disadvantage is that polypropylene has a usable upper temperature limit of 121° C. These food trays are thus limited to microwave ovens and regeneration ovens operating with temperatures below 115° C.

In situations in which a higher heating temperature is required, such as when a larger number of frozen food trays are to be heated at the same time, food trays made from polyethylene terephthalate (PET) are used. These food trays are made in a thermoforming process, in which a food tray having a bottom part is produced, and where the bottom part is then removed.

The food tray is adapted to be supplied with food in a filling station at a ready meal producer. This may be either a manually operated filling station or an automated filling station. When all food products are inserted into the food tray, a lid is mounted to the upper rim of the food tray. The lid is preferably mounted to the food tray in a heat sealing operation, but it is also possible to use a lid that is not fixedly attached to the upper rim, e.g. when fresh ready meals are prepared for catering. Commonly known heat sealing apparatuses or machines comprising a heated plate may be used, but since the lid should not be removable, other materials, temperatures and processing times may be used.

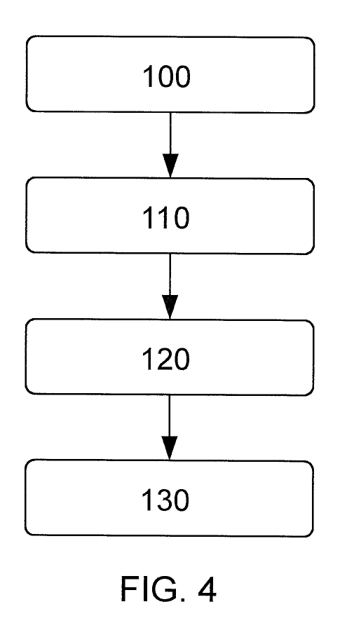

A flow chart of a method for producing a food tray, where the food tray comprises a side wall module and a removable bottom is shown in FIG. 4. The removable bottom is attached to a lower rim of the side wall module by a rim section in a fixed manner, and the removable bottom is provided with a perforation that will break when the removable bottom is removed from the side wall module by the use of a removal means attached to the bottom.

In step 100, a food tray having side walls and a bottom part is produced by either thermoforming or injection moulding. A suitable material is polypropylene (PP) or polyethylene terephthalate (PET). By using PET, a food tray having a removable bottom that withstands temperatures in the range between 150° C. up to 210° C. can be obtained.

In step 110, a bottom foil is produced, where the bottom foil will constitute a removable bottom when attached to the side wall module. The bottom foil comprises a perforation along the outer periphery of the bottom foil.

The perforation and the bottom foil are preferably cut at the same time, e.g. by using laser or a cutting tool. The perforation extends through part of the thickness of the foil, e.g. through half or three quarters of the thickness of the foil. It is important that the perforation does not extend through the complete thickness of the bottom foil.

In step 120, the rim section of the bottom foil is attached to a lower rim of the side wall module in a fixed manner. The bottom foil is either attached to the inner side of the lower rim, or is attached to the outer side of the lower rim. In this way, the removable bottom is attached to the side wall module in a secure way.

In step 130, a removal means is fixedly attached to the removable bottom. The removal means is attached to the removable bottom by an attachment section, which is attached close to the perforation at a side opposite the side where the handle is pulled. In this way, the removable bottom can be peeled off in an easy way.

The invention is not to be regarded as being limited to the embodiments described above, a number of additional variants and modifications being possible within the scope of the subsequent patent claims. The food tray may have any size and/or shape.

### REFERENCE SIGNS

1: Food tray
2: Side wall module
3: Longitudinal side wall
4: Longitudinal side wall
5: Transverse side wall
6: Transverse side wall
7: Concave section
8: Concave section
9: Handle
11: Upper rim
12: Lower rim
13: Removable bottom
14: Removal tab
15: Lower opening
16: Perforation
17: Rim section
18: Attachment section

1. A food tray (1) comprising a side wall module (2) and a removable bottom (13), where the removable bottom (13) comprises a rim section (17) which is attached to a lower rim (12) of the side wall module (2), characterized in that the rim section (17) is fixedly attached to the lower rim (12) of the side wall module (2) and that the removable bottom (13) is provided with a perforation (16) adjacent the rim section (17), such that the removable bottom (13) can be removed from the rim section (17) by the use of a removal means (14) fixedly attached to the removable bottom (13).

2. Food tray according to claim 1, characterized in that the rim section (17) is attached to the inner side of the lower rim (12).

3. Food tray according to claim 1 or 2, characterized in that the removal means (14) is attached to a corner of the removable bottom (13).

4. Food tray according to claim 1 or 2, characterized in that the removal means (14) is attached along a short side of the removable bottom (13).

5. Food tray according to any of the preceding claims, characterized in that the perforation (16) extends along a short side (6) and two long sides (3, 4) of the side wall module (2).

6. Method of producing a food tray, where the food tray comprises a side wall module (2) and a removable bottom (13), where the removable bottom (13) comprises a rim section (17), where the rim section (17) of the removable bottom (13) is attached to the side wall module (2) in a fixed manner, and where the removable bottom (13) can be removed from the side wall module (2) by the use of a removal means (14) attached to the removable bottom (13), characterized in that the method comprises the steps of:
producing a side wall module having side walls and a lower opening,
producing a bottom foil, where the bottom foil comprises a perforation along the rim section,
attaching the rim section of the bottom foil to a lower rim of the side wall module in a fixed manner, and
attaching the removal means to the removable bottom in a fixed manner.

7. Method according to claim 6, characterized in that the bottom foil is laser cut and that the perforation is laser cut at the same time.

8. Method according to claim 6 or 7, characterized in that the perforation extends along a short side and two long sides of the removable bottom.

9. Method according to any of claims 6 to 8, characterized in that the rim section is attached to an inner side of the lower rim.

10. Method according to any of claims 6 to 9, characterized in that the removal means (14) is attached to a corner of the removable bottom.

11. Method according to any of claims 6 to 9, characterized in that the removal means (14) is attached along a short side of the removable bottom.

12. Method according to any of claims 6 to 11, characterized in that the removal means is double folded, extends over the complete removable bottom and that a handle of the removal means is attached to an outer side of the food tray in a detachable manner.

13. Method according to any of claims 6 to 12, characterized in that the food tray is formed from a plastic sheet made of polyethylene terephthalate (PET).

14. Method according to claim 13, characterized in that the food tray is formed from a plastic sheet made of crystalline polyethylene terephthalate (CPET).

15. Method according to any of claims 6 to 12, characterized in that the food tray is injection moulded from a polypropylene material.
